(19) United States
(12) Patent Application Publication
(10) Pub. No.: US 2019/0256344 A1
(43) Pub. Date: Aug. 22, 2019

(54) APPARATUS, SYSTEM, AND METHOD FOR A FUEL DISPENSER SUMP CONDUIT SUPPORT

(71) Applicant: Cap-It, LLC, Marriott-Slaterville, UT (US)

(72) Inventors: Jason Williams, Farr West, UT (US); Travis Hess, Mariott-Slaterville, UT (US)

(21) Appl. No.: 15/900,803

(22) Filed: Feb. 21, 2018

(51) Int. Cl. B67D 7/40

(52) U.S. Cl. CPC B67D 7/40

(57) ABSTRACT

A fuel dispenser sump conduit support. The fuel dispenser sump conduit support includes a conduit attachment structure, a bracket, and a sump interface. The bracket is connected to the conduit attachment structure at a bracket interface. The sump interface is disposed on the bracket distally from the from the bracket interface. The sump interface includes a surface connectable to a fuel dispenser sump.

### CROSS-REFERENCE TO RELATED APPLICATIONS

N/A

### SUMMARY

An embodiment of the invention provides a fuel dispenser sump conduit support. The fuel dispenser sump conduit support includes a conduit attachment structure, a bracket, and a sump interface. The bracket is connected to the conduit attachment structure at a bracket interface. The sump interface is disposed on the bracket distally from the from the bracket interface. The sump interface includes a surface connectable to a fuel dispenser sump. Other embodiments are also described.

### BRIEF DESCRIPTION OF THE SEVERAL VIEWS OF THE DRAWINGS

FIG. 1 depicts a perspective view of one embodiment of a fuel dispenser sump.

FIG. 2 depicts a perspective view of one embodiment of a fuel dispenser sump conduit support attached to a fuel dispenser sump.

FIG. 3 depicts a perspective view of the fuel dispenser sump conduit support of FIG. 2.

FIG. 4 depicts a side view of the fuel dispenser sump conduit support attached to the fuel dispenser sump of FIG. 2.

FIG. 5 depicts a perspective view of one embodiment of a fuel dispenser sump conduit support attached to a fuel dispenser sump.

FIG. 6 depicts a perspective view of one embodiment of a fuel dispenser sump conduit support attached to a fuel dispenser sump.

FIG. 7 is a flowchart diagram depicting one embodiment of a method of use of a fuel dispenser sump conduit support.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide an apparatus for a fuel dispenser sump conduit support configured to support conduit for use with a fuel dispenser sump.

As used herein, the terms “above,” “below,” and other similar terms refer to relative elevations of components in an installed fuel dispenser sump system. A fuel dispenser sump is typically installed in a particular orientation, and a component of the fuel dispenser sump system referred to as “above” another component has a higher elevation than the other component if the fuel dispenser sump system is installed in its typical orientation.

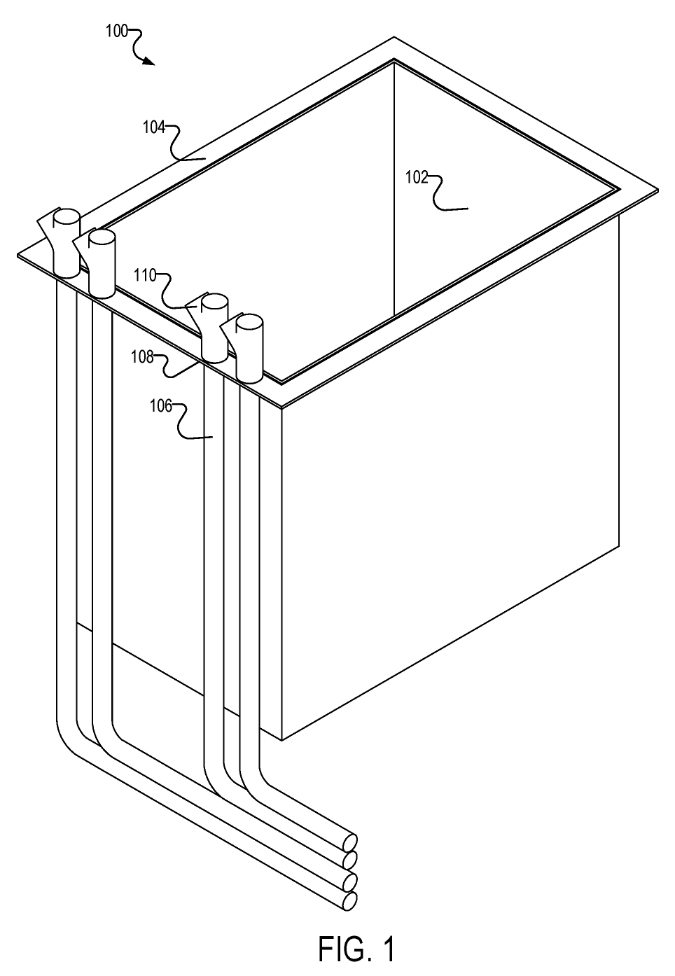

FIG. 1 depicts a perspective view of one embodiment of a fuel dispenser sump 100. The fuel dispenser sump 100 includes a sump body 102 and a mounting flange 104. The fuel dispenser sump 100 provides a foundation for mounting a fuel dispenser (not shown).

The sump body 102, in one embodiment, is a liquid-tight, open-topped vessel capable of containing fuel. The sump body 102 may provide containment for spilled fuel. In certain embodiments, the sump body 102 may be installed such that it is buried in the ground or substantially encased in concrete. In one embodiment, the sump body 102 may be installed such that a top opening of the sump body 102 is exposed while the remainder of the sump body 102 is buried or encased in other material.

The sump body 102 may include any material having the mechanical properties to perform the functions of the sump body 102. For example, the sump body 102 may include plastics, metals, or composite materials. In one embodiment, the sump body 102 includes fiberglass material. In another embodiment, the sump body 102 includes glass-filled nylon. The sump body 102 may include any material known in the art, including polymers, alloys, natural materials, synthetic materials, or combinations of materials. Examples of materials that may be included in the sump body 102 include PVC, acrylonitrile butadiene styrene (ABS), nylon, polylactic acid (PLA), polycarbonate (PC), polyeter sulfone (PES), polyetherether ketone (PEEK), polyetherimide (PEI), polyethylene (PE), polyphenylene oxide (PPO), polyphenylene sulfide (PPS), polypropylene (PP), polystyrene, polyurethane, phenol-formaldehyde, melamine, diallyl-phthalate (DAP), epoxy, polyimides, cyanates, vulcanized rubber, steel, aluminum, carbon fiber, glass fiber, or the like

The sump body 102, in some embodiments, is connected to a mounting flange 104. The mounting flange 104 provides a mounting surface for other components. Examples of components that may be mountable to the mounting flange 104 include a fuel dispenser (not shown), one or more conduits 106, and other components.

The mounting flange 104 may include any material capable of performing the functions of the mounting flange 104, including any material listed above. In certain embodiments, the mounting flange 104 includes stainless steel. In one embodiment, the mounting flange 104 is a metal rectangle with an open interior that substantially or entirely surrounds the top opening of the sump body 102.

In an alternative embodiment, the mounting flange 104 may include a strut channel. For example, the mounting flange 104 may include a length of Unistrut® channel configured to receive one or more fittings, such as pipe clamps or conduit hangers.

In certain embodiments, the mounting flange 104 includes a conduit connector 108. The conduit connector 108 is configured to receive a conduit 106. In some embodiments, the conduit connector 108 is configured to restrict translation of the conduit 106 in one or more directions. For example, the conduit connector 108 may include a pipe clamp that restricts or resists translation of an attached 106 conduit in any direction. In another example, the conduit connector 108 may include an aperture that allows an attached conduit 106 to translate in one direction but restricts movement of the conduit 106 in one or more perpendicular directions.

In one embodiment, mounting flange 104 includes a flat or substantially flat component and the conduit connector 108 includes an aperture in the flat or substantially flat component. In this embodiment, the aperture allows insertion of a conduit 106 and restricts translation of the conduit 106 in directions perpendicular to the direction of insertion. In other words, the aperture allows translation of the conduit 106 in a direction perpendicular to the flat component, but restricts translation of the conduit in directions parallel to the flat component.

A fitting 110 may be attached to the conduit 106 in certain embodiments. The fitting 110 may be sized such that it interferes with the conduit connector 108 and restricts motion of the fitting 110 and the attached conduit 106 relative to the conduit connector 108. For example, the conduit connector 108 may include an aperture and the fitting 110 may be a seal off fitting that has a profile that extends beyond the aperture. In this example, the seal off fitting may restrict motion of the fitting and the attached conduit 106 beyond the aperture.

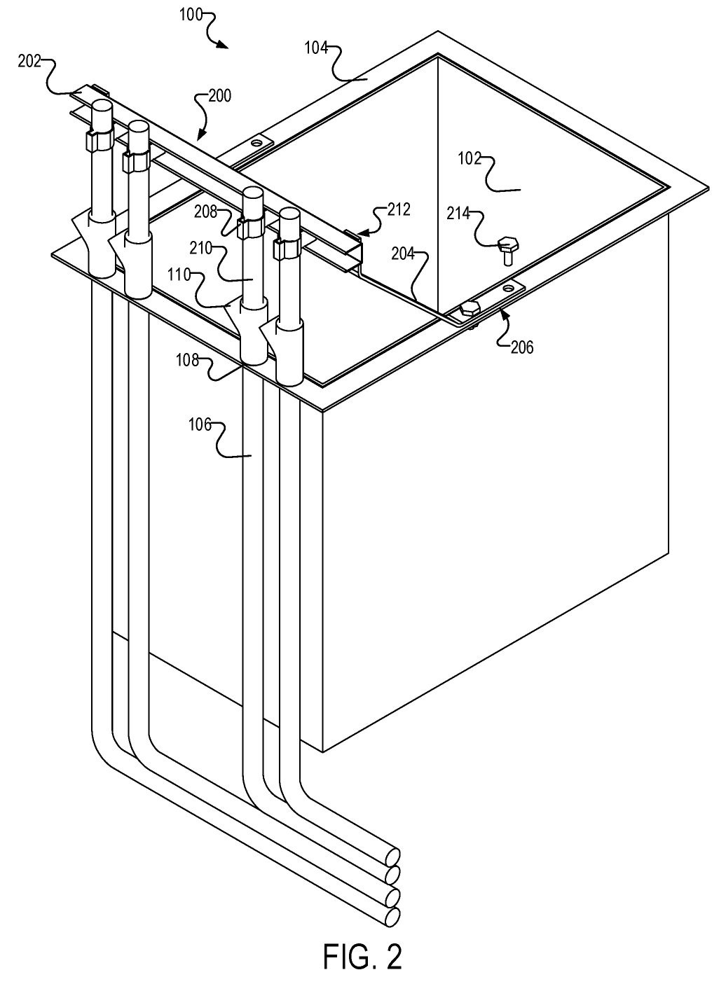

FIG. 2 depicts a perspective view of one embodiment of a fuel dispenser sump conduit support 200 attached to a fuel dispenser sump 100. The fuel dispenser sump 100 is similar to the like-numbered component described in relation to FIG. 1. The fuel dispenser sump conduit support 200 includes a conduit attachment structure 202, a bracket 204, and a sump interface 206. The fuel dispenser sump conduit support 200 provides a second attachment point for conduit 106 connected to the fuel dispenser sump 100.

The conduit attachment structure 202, in one embodiment, provides one or more conduit connectors 208 for securing conduit 106. The conduit attachment structure 202 may be a rigid structure secured in place relative to the fuel dispenser sump 100. The conduit attachment structure 202 may include any material capable of performing the functions of the conduit attachment structure 202, including any material listed above. In one embodiment, the conduit attachment structure 202 includes a strut channel. For example, the conduit attachment structure 202 may include a length of Unistrut® channel configured to receive one or more fittings, such as pipe clamps or conduit hangers.

In certain embodiments, the one or more conduit connectors 208 are second conduit connectors, with a conduit connector 108 disposed on the fuel dispenser sump 100 representing a first conduit connector. The first conduit connector 108 and the second conduit connector 208 may be separated by a predetermined distance. A conduit 106 may be connected to both the first conduit connector 108 and the second conduit connector 208. A conduit 106 connected to the first conduit connector 108 and the second conduit connector 208 may result in substantially more stable retention of the conduit relative to relative to a conduit 106 connected by a single conduit connector. This may result in a higher probability that the conduit 106 will remain in a desired position through construction activities taking place around the fuel dispenser sump 100.

In certain embodiments, the first conduit connector 108 and the second conduit connector 208 are disposed one above the other or substantially one above the other. As a result, a conduit connected to both first conduit connector 108 and the second conduit connector 208 will be retained in a vertical or substantially vertical position, respectively.

The conduit connector 208 is configured to receive a conduit 106. In some embodiments, the conduit connector 208 is configured to restrict translation of the conduit 106 in one or more directions. For example, the conduit connector 208 may include a pipe clamp or a conduit hanger that restricts or resists translation of an attached 106 conduit in any direction. The conduit connector 208 may include a strut conduit clamp that interfaces with a strut channel and a conduit 106 to secure the conduit 106 relative to the strut channel. The strut conduit clamp may include a clamp that fastens a conduit 106 relative to the strut conduit clamp.

In another example, the conduit connector 208 may include an aperture that allows an attached conduit 106 to translate in one direction but restricts movement of the conduit 106 in one or more perpendicular directions. In one embodiment, conduit attachment structure 202 includes a flat or substantially flat component and the conduit connector 208 includes an aperture in the flat or substantially flat component. In this embodiment, the aperture allows insertion of a conduit 106 and restricts translation of the conduit 106 in directions perpendicular to the direction of insertion. In other words, the aperture allows translation of the conduit 106 in a direction perpendicular to the flat component, but restricts translation of the conduit in directions parallel to the flat component.

In some embodiments, the conduit 106 may be attached to a fitting 110. In certain embodiments, a conduit nipple 210 may be connected to the fitting 110. For example, the conduit nipple 210 may provide a temporary extension of the conduit 106 for use with the fuel dispenser sump conduit support 200 such that the conduit nipple 210 connects to the conduit connector 208 disposed on the conduit attachment structure 202. In this example, the conduit nipple 210 acts as a part of the conduit 106 as described above, and descriptions that disclose structures, functions, and features of the conduit 106 may be imputed to the conduit nipple 210. In some embodiments, the conduit nipple 210 may be removed after construction activity progresses to the point that disturbance of the position of the conduit 106 is less likely.

The bracket 204, in some embodiments, retains the conduit attachment structure 202 in position relative to the fuel dispenser sump 100. The bracket 204 is connected to the conduit attachment structure at a bracket interface 212. The bracket 204 may be permanently connected to or removably connected to the conduit attachment structure 202. For example, the bracket 204 may be permanently connected to the conduit attachment structure 202 by a weld. In another example, the bracket 204 may be removably connected to the conduit attachment structure 202 by a fastener.

The bracket 204 may include any material capable of performing the functions of the bracket 204, including any material listed above. In one embodiment, the bracket 204 includes a steel bar including two bends configured to hold the conduit attachment structure 202 in a predetermined position relative to the fuel dispenser sump 100.

In one embodiment, the bracket 204 is connected to the fuel dispenser sump 100 at a sump interface 206. The sump interface 206 is distal from the bracket interface 212. For example, the bracket interface 212 may be disposed at or near a first end of the bracket 204 and the sump interface 206 may be disposed at or near a second end of the bracket 204.

The bracket 204 is removably connected to the fuel dispenser sump 100 at the sump interface 206 in some embodiments. The removable connection may include any removable connection known in the art. For example, the removable connection may include a fastener 214 such as a bolt or a machine screw configured to connect a surface of the sump interface 206 to the fuel dispenser sump 100. In another embodiment, the removable connection includes a compliant connection that deforms under force and springs into a securing position in response to the sump interface 206 being placed in a predetermined position relative to the fuel dispenser sump 100.

In some embodiments, the fuel dispenser sump support 200 is removable from the fuel dispenser sump 100. For example, the fuel dispenser sump support 200 may be attached to the fuel dispenser sump 100, to one or more conduits 106, to one or more conduit nipples 210, to one or more fittings 110, or any combination of these components in preparation for construction activities that may otherwise displace the one or more conduits 106. In response to a determination that the one or more conduits 106 are no longer likely to be disturbed, the fuel dispenser sump support 200 may be removed from the fuel dispenser sump 100 and any attached components.

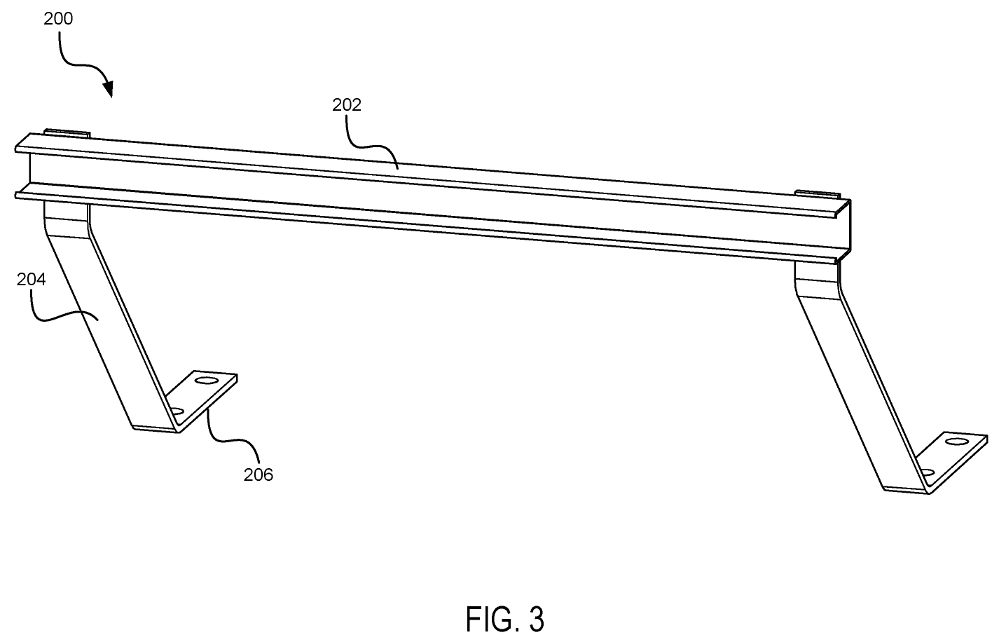

FIG. 3 depicts a perspective view of the fuel dispenser sump conduit support 202 of FIG. 2. The fuel dispenser sump conduit support 202 includes the conduit attachment structure 202, the bracket 204, and the sump interface 206. The fuel dispenser sump conduit support 202 is similar to the like numbered component described above.

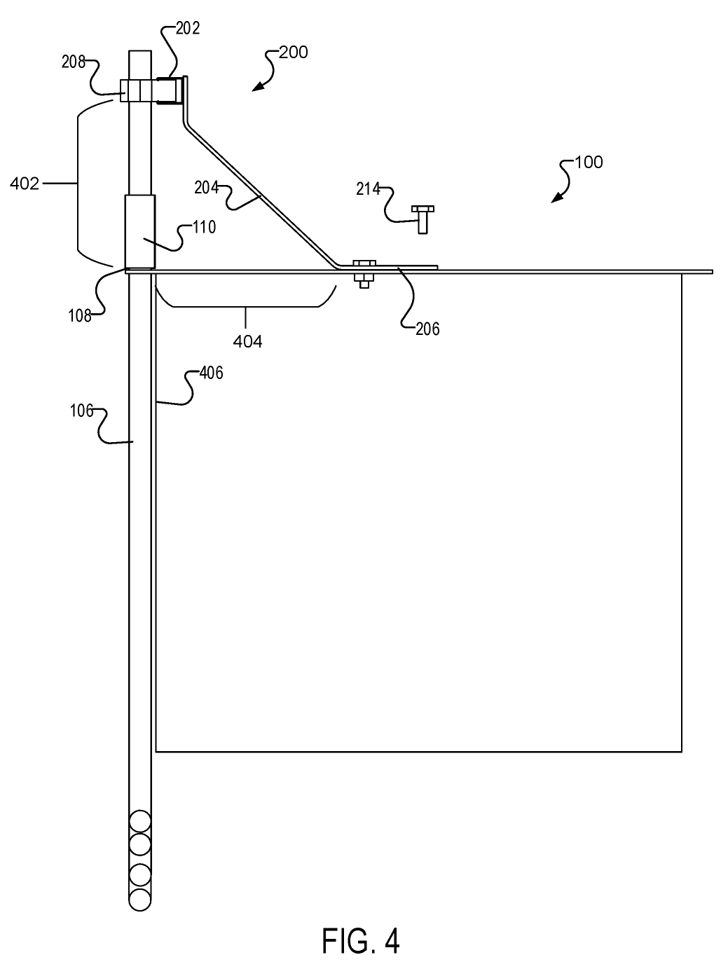

FIG. 4 depicts a side view of the fuel dispenser sump conduit support 200 attached to the fuel dispenser sump 100 of FIG. 2. The fuel dispenser sump 100 is similar to the like-numbered structure described in relation to FIG. 1. The fuel dispenser sump conduit support 200 is similar to the like-numbered structure described in relation to FIGS. 2 and 3 and includes the conduit attachment structure 202, the bracket 204, and the sump interface 206. The fuel dispenser sump conduit support 200 provides a second attachment point for conduit 106 connected to the fuel dispenser sump 100.

In certain embodiments, the first conduit connector 108 and the second conduit connector 208 are separated by a predetermined conduit attachment distance 402. The predetermined conduit attachment distance 402, in some embodiments, is influenced by a geometry of the bracket 204. For example, the bracket 204 may be formed to position the second conduit connector 208 approximately ten inches away from the first conduit connector 108. In this example, the predetermined conduit attachment distance 402 is approximately ten inches.

In some embodiments, the predetermined conduit attachment distance 402 is the distance between the second conduit connector 208 and a plane defined by a top of the fuel dispenser sump 100. The predetermined conduit attachment distance 402 may be measured as a perpendicular distance between the plane and the second conduit connector 208.

In some embodiments, the conduit attachment structure 202 is separated from the fuel dispenser sump 100 by the predetermined conduit attachment distance 402. The conduit attachment structure 202 may be positioned such that the entirety of the conduit attachment structure 202 is positioned at least three inches from any part of the fuel dispenser sump 100.

As will be appreciated by one skilled in the art, the predetermined conduit attachment distance 402 may be any distance that creates a desired resistance to motion of the conduit 106. In some embodiments, the predetermined conduit attachment distance 402 may be a distance that allows a fitting 110 to be disposed on the conduit between the first conduit connector 108 and the second conduit connector 208. For example, the predetermined conduit attachment distance 402 may be at least three inches. In another embodiment, the predetermined conduit attachment distance 402 may be between eight and twelve inches.

In some embodiments, the sump interface 206 and a connector side wall 406 of the fuel dispenser sump 100 are separated by a predetermined sump interface distance 404. The predetermined sump interface distance 404 may be sized to allow for access to other components of the fuel dispenser sump 100 or the fuel dispenser sump conduit support 200. In one embodiment, the predetermined sump interface distance 404 is approximately ten inches.

As will be appreciated by one skilled in the art, the predetermined sump interface distance 404 may be any distance that creates a desired clearance between the bracket 204 and other components. For example, the predetermined sump interface distance 404 may be at least three inches. In another embodiment, the predetermined sump interface distance 404 may be between eight and twelve inches.

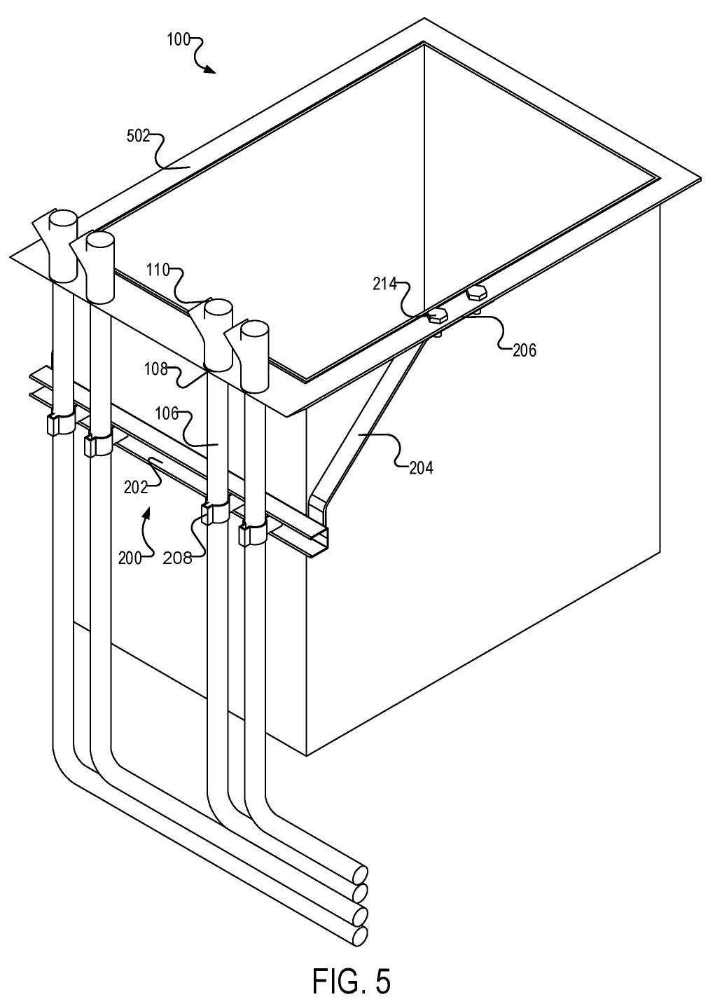

FIG. 5 depicts a perspective view of one embodiment of a fuel dispenser sump conduit support 200 attached to a fuel dispenser sump 100. The fuel dispenser sump 100 and the fuel dispenser sump conduit support 200 may be similar to like-numbered components described above in relations to FIGS. 1-4. In certain embodiments, the fuel dispenser sump conduit support 200 is connected to the fuel dispenser sump 100 such that the second conduit attachment point 208 is disposed below the first conduit attachment point 108. For example, the bracket 204 may extend in a direction that positions the conduit attachment structure 202 below the first conduit connector 108.

In certain embodiments, the predetermined conduit attachment distance 402 between the first conduit attachment point 108 and the second conduit attachment point 208 is similar to the predetermined conduit attachment distance 402 described above. The predetermined conduit attachment distance 402 may be a distance greater than three inches, between eight and twelve inches, approximately ten inches, or any other distance.

In some embodiments, the fuel dispenser sump conduit support 200 is attached to the fuel dispenser sump 100 at the sump interface 206. The connection at the sump interface 206 may employ any known connecting method or structure, such as a fastener 214, a weld, or an integrally formed connection. In some embodiments the connection at the sump interface 206 is removable. In other embodiments, the connection at the sump interface 206 is not removable.

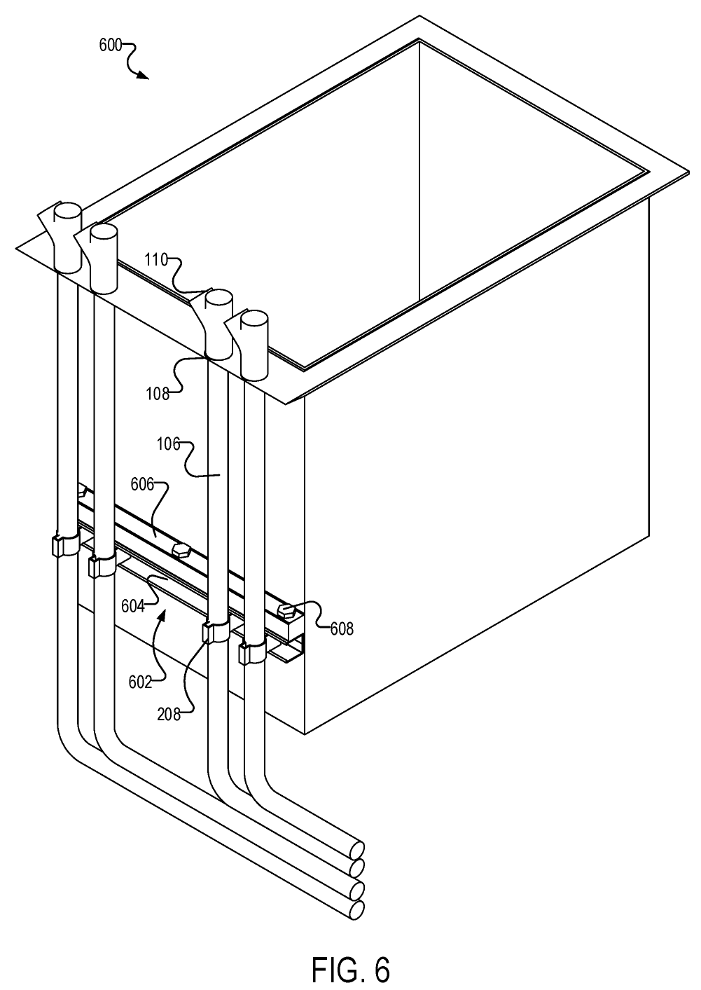

FIG. 6 depicts a perspective view of one embodiment of a fuel dispenser sump conduit support 602 attached to a fuel dispenser sump 600. The fuel dispenser sump 100 includes a first conduit connector 108. The fuel dispenser sump conduit support 602 includes a conduit attachment structure 604 and a second conduit connector 208. The first conduit connector 108 and the second conduit connector 208 are similar to like-numbered components described above. The conduit support 602 provides a second connection location for one or more conduits 106.

In certain embodiments, the conduit attachment structure 604 is disposed on the fuel dispenser sump 600 at a location below the first conduit connector 108. The second conduit connector 208 is disposed on the conduit attachment structure 604 using any structure or method described herein for a conduit connector.

In certain embodiments, the conduit attachment structure 604 is connected to the fuel dispenser sump 600 using one or more fasteners 608. In an alternate embodiment, the conduit attachment structure 604 is connected to the fuel dispenser sump 600 via an adhesive. In some embodiments, a mounting lug 606 is attached to the fuel dispenser sump 600 and the conduit attachment structure 604 is attached to the mounting lug 606. In one embodiment, the mounting lug 606 is formed integrally with the fuel dispenser sump 600. In some embodiments, the conduit attachment structure 604 is attached to the fuel dispenser sump 600 in a manner that does not result in penetration of the fuel dispenser sump 600.

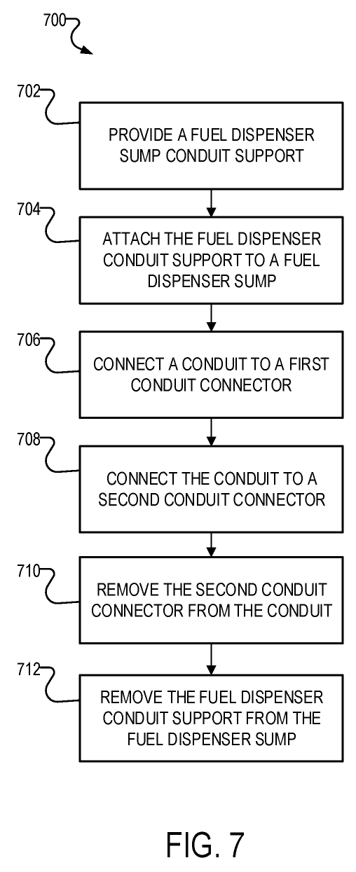

FIG. 7 is a flowchart diagram depicting one embodiment of a method of use of a fuel dispenser sump conduit support. The method is, in certain embodiments, a method of use of the system and apparatus of FIGS. 1-6, and will be discussed with reference to those figures. Nevertheless, the method may also be conducted independently thereof and is not intended to be limited specifically to the specific embodiments discussed above with respect to those figures.

FIG. 7 illustrates a method 700 for using a fuel dispenser sump conduit support 200. As shown in FIG. 7, a fuel dispenser sump conduit support 200 is provided 702. The fuel dispenser conduit support 200 is attached 704 to a fuel dispenser sump 100. The attachment may be a removable attachment.

A conduit 106 is connected 706 to a first conduit connector 108. The first conduit connector 108 is disposed on the fuel dispenser sump 100 in some embodiments. The conduit 106 is connected 708 to a second conduit connector 208. In some embodiments, the second conduit connector 208 is disposed on the fuel dispenser sump conduit support 200.

In some embodiments, the first conduit connector 108 and the second conduit connector 208 are separated by a predetermined conduit attachment distance 402. The conduit 106 may include other components, such as a fitting 110 or a conduit nipple 112 which may be connected to the first conduit connector 108 or the second conduit connector 208. Collectively, the conduit 106, the fitting 110, the conduit nipple 112, or any combination of these may be referred to as a “conduit.”

In some embodiments, the second conduit connector 208 is removed 710 from the conduit 106. The second conduit connector 208 may be removed 710 from the conduit 106 after construction activity that is likely to disturb the conduit 106 is completed. The fuel dispenser conduit support 200 is removed 712 from the fuel dispenser sump 100 in some embodiments.

The components described herein may include any materials capable of performing the functions described. Said materials may include, but are not limited to, steel, stainless steel, titanium, tool steel, aluminum, polymers, and composite materials. The materials may also include alloys or combinations of any of the above materials. The materials may undergo any known treatment process to enhance one or more characteristics, including but not limited to heat treatment, hardening, forging, annealing, and anodizing. Materials may be formed or adapted to act as any described components using any known process, including but not limited to casting, extruding, injection molding, machining, milling, forming, stamping, pressing, drawing, spinning, deposition, winding, molding, and compression molding.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by any claims appended hereto and their equivalents.

What is claimed is:

1. A fuel dispenser sump conduit support comprising:
a conduit attachment structure configured to secure at least one conduit;
a bracket connected to the conduit attachment structure at a bracket interface; and
a sump interface disposed on the bracket distally from the from the bracket interface, the sump interface comprising a surface connectable to a fuel dispenser sump.

2. The fuel dispenser sump conduit support of claim 1, further comprising a fastener to secure the sump interface to the fuel dispenser sump.

3. The fuel dispenser sump conduit support of claim 2, wherein the fastener is removable.

4. The fuel dispenser sump conduit support of claim 2, wherein the fastener comprises a bolt.

5. The fuel dispenser sump conduit support of claim 1, further comprising a conduit hanger connected to the conduit attachment structure.

6. The fuel dispenser sump conduit support of claim 1, wherein the conduit attachment structure comprises a strut channel.

7. The fuel dispenser sump conduit support of claim 6, further comprising a strut conduit clamp disposed on the strut channel, the strut conduit clamp comprising a clamp to fasten a conduit.

8. The fuel dispenser sump conduit support of claim 1, wherein the conduit attachment structure comprises an aperture sized to receive a conduit.

9. The fuel dispenser sump conduit support of claim 1, wherein the conduit attachment structure is positioned a distance perpendicular to a plane defined by a top of a fuel dispenser sump connected to the fuel dispenser sump conduit support at the sump interface.

10. The fuel dispenser sump conduit support of claim 9, wherein the conduit attachment structure is at least three inches above the plane.

11. The fuel dispenser sump conduit support of claim 9, wherein the conduit attachment structure is between eight and twelve inches above the plane.

12. The fuel dispenser sump conduit support of claim 9, wherein the conduit attachment structure is at least three inches below the plane.

13. The fuel dispenser sump conduit support of claim 1, wherein connecting the sump interface to the fuel dispenser sump causes the conduit attachment structure to be positioned at least three inches away from any part of the fuel dispenser sump.

14. A system for securing conduit to a fuel dispenser sump comprising:
a fuel dispenser sump comprising:
a sump body;
a mounting flange connected to the sump body; and
a first conduit connector disposed on the mounting flange;
a fuel dispenser sump conduit support comprising:
a conduit attachment structure;
a second conduit connector disposed on the conduit attachment structure;
a bracket connected to the conduit attachment structure at a bracket interface; and
a sump interface disposed on the bracket distally from the bracket interface, the sump interface removably connectable to the mounting flange; and
a conduit connectable to the first conduit connector and removably connectable to the second conduit connector.

15. The system of claim 14, wherein the second conduit connector is at least three inches from the first conduit connector in response to connecting the sump interface to the mounting flange.

16. The system of claim 14, wherein the second conduit connector and the first conduit connector are positioned to secure a conduit in a substantially vertical position in response to connecting the sump interface to the mounting flange.

17. The system of claim 14, wherein the second conduit connector is a clamp that restricts translation of the conduit relative to the second conduit connector in any direction.

18. The system of claim 14, wherein the second conduit connector restricts motion of the conduit relative to the second conduit connector in a first direction and allows motion of the conduit relative to the second conduit connector in a second direction, the second direction perpendicular to the first direction.

19. The system of claim 14, further comprising a fitting connected to the conduit, and a conduit nipple connected to the fitting.

20. A fuel dispenser sump conduit support comprising:
a conduit attachment structure comprising a strut channel and a conduit hanger configured to secure at least one conduit;
a bracket connected to the conduit attachment structure at a bracket interface;
a sump interface disposed on the bracket distally from the from the bracket interface, the sump interface comprising a surface connectable to a fuel dispenser sump; and
a removable fastener to secure the sump interface to the fuel dispenser sump;
wherein connecting the sump interface to the fuel dispenser sump causes the conduit attachment structure to be positioned at least three inches away from any part of the fuel dispenser sump.
